(19) United States
(12) Patent Application Publication
(10) Pub. No.: US 2020/0233002 A1
(43) Pub. Date: Jul. 23, 2020

(54) MULTIPLE SAMPLE AUTOMATIC GRAVIMETRIC DOSING AND CLEANING SYSTEM

(71) Applicant: Jose Maria Las Navas Garcia, Conway, SC (US)

(72) Inventor: Jose Maria Las Navas Garcia, Conway, SC (US)

(21) Appl. No.: 16/709,141

(22) Filed: Dec. 10, 2019

Related U.S. Application Data
(60) Provisional application No. 62/793,695, filed on Jan. 17, 2019.

(51) Int. Cl. G01N 35/10; G01N 35/02; G01N 35/04

(52) U.S. Cl. CPC G01N 35/1004; G01N 2035/0437; B01L 13/02; G01N 35/025

(57) ABSTRACT

A multiple sample automatic dosing and cleaning system comprising a first receiving carousel for sequentially receiving multiple samples in sample cups for automatic sequential filling a dosing head. The receiving carousel is rotated around its axis and synchronized with the dosing device. Each destination cup is weighed empty on a balance scale in the destination carousel having openings for multiple cups. The destination carousel has means for rotation movement and vertical and horizontal movement. The destination carousels empty and tared cups placed on the balance scale receive the samples and flux for automatic dosing. A cleaning vacuum device is used to clean the dosing head every time each sample is dosed for integrity sample dosing. The carousels are serviced by gantry support which provides linear and vertical movement of the dosing device.

### CROSS-REFERENCE TO RELATED APPLICATON(S)

The contents of Provisional Application U.S. Ser. No. 62/793,695 filed Jan. 17, 2019 on which the present application is based, and benefits claimed under 35 U.S.C. § 119(e), is herein incorporated by reference.

### BACKGROUND OF THE INVENTION

### 1. Field of the Invention

The present invention relates to a multiple sample automatic gravimetric dosing and cleaning system. More particularly, the present invention relates to an automatic dosing system providing the capability to automatically dose a sample and then clean the dosing the dosing device.

### 2. Description of Related Art

Systems for analyzing a dosed sample of product, i.e., liquid and/or granular, are commonly known and have been in use for many years. They include a gravimetric weighing system in which samples are placed in a crucible or cup and the weight of the sample and cup is measured before dosing. After the sample is dosed the sample is again weighed and the amount of dosage material is determined. It is well known that measuring the amount of dosing powder and/or granules of different products is complicated due to the cross-contamination from sample to sample dosing. Therefore, cleaning the dosing device thoroughly is necessary in order to get a true reading.

### SUMMARY OF THE INVENTION

It is therefore the general object of the present invention to provide an automatic system sample dosing system.

It is another object of the present invention to provide a dosing device cleaning system to cleaning the dosing device from sample to sample.

It is yet another object of the present invention to provide a vibrating mechanism to assist in the automatic cleaning of the dosing the dosing device.

This invention provides a multiple sample automatic dosing and cleaning system. There is provided a first receiving carousel, located on a table, for sequentially receiving multiple samples in sample cups for automatic sequential picking up samples and later dosing. The receiving carousel is rotated around its axis and synchronized with the dosing device. Each sample cup loaded with sample. On another portion of table is a destination carousel having openings for receiving the dosed samples. The destination carousel has means for rotation movement and vertical and horizontal movement. The dosed samples in the destination carousel are weighed in a balance scale. The carousels are serviced by a gantry support which provides linear and vertical movement of the dosing device.

The samples are dosed by a dosing device having a dosing head and being capable of moving the samples from the receiving carousel, dosing said samples though the dosing head through which the dosing material is moved into the sample cup and moving the samples to the destination carousel. A cleaning mechanism is provided for cleaning the dosing head following each dosing. The cleaning mechanism is positioned between the first receiving carousel and the destination carousel. The dosing and cleaning system also includes a vibrating mechanism positioned between the first receiving carousel and the destination carousel to vibrate the samples to facilitate the dosing device entrance to the sample and to release particles on the device surface to the sample cup. There is provided a secondary dosing device and/or flux device for dosing flux together with the samples.

The method of the present invention provides numerous advantages over the prior art as it provides the ability to rapidly, automatically and accurately clean the dosing device.

Other objectives, features and advantages of the present invention will become apparent from the following detailed description of the invention taken in conjunction with the accompanying drawings.

### BRIEF DESCRIPTION OF THE DRAWINGS

Having described the invention in general terms, reference will now be made to the accompanying drawings, which are not necessarily drawn to scale, in which like numerals refer to like parts and in which:

FIG. 1 is an overall perspective view of the multiple sample automatic gravimetric dosing system of the present invention illustrating the major elements of the dosing and cleaning system and their relationship to each other;

FIG. 2 shows a portion of the dosing system of the present invention providing an overview of the cleaning system and illustrating the dosing device picking up a sample from the receiving carousel;

FIG. 3 shows that portion of the dosing and cleaning system of the present invention illustrating the dosing device head and secondary dosing device with the dosing device retracted above the receiving carousel;

FIG. 4 is a perspective view of that portion of the dosing and cleaning system of the present invention showing the vacuum pump and the cleaning station for receiving the dosing device head;

FIG. 5 is a perspective view of the dosing and cleaning system of the present invention illustrating the gantry assembly controlling the linear, horizontal and vertical movement of the dosing device along with the vibration mechanism;

FIG. 6 is a side view of the destination carousel assembly illustrating the destination carousel, the balance scale and the means for controlling the rotational, linear, vertical and horizontal movement of the destination carousel of the present invention;

FIG. 7 is a perspective view of the dosing device head of the present invention illustrating the dosing head attached to the dosing head housing and the housing attached to the motor for rotating the dosing head; and

FIG. 8 is an exploded view of the dosing device of the present invention shown in FIG. 7.

### DESCRIPTION OF THE PREFERRED EMBODIMENT(S)

The present inventions now will be described more fully hereinafter with reference to the accompanying drawings, in which preferred embodiments of the invention are shown. This invention may, however, be embodied in many different forms and should not be construed as limited to the embodiments set forth herein; rather these embodiments are provided so that this disclosure will be through and complete and will fully convey the scope of the invention to those skilled in the art. Like numbers refer to the elements throughout.

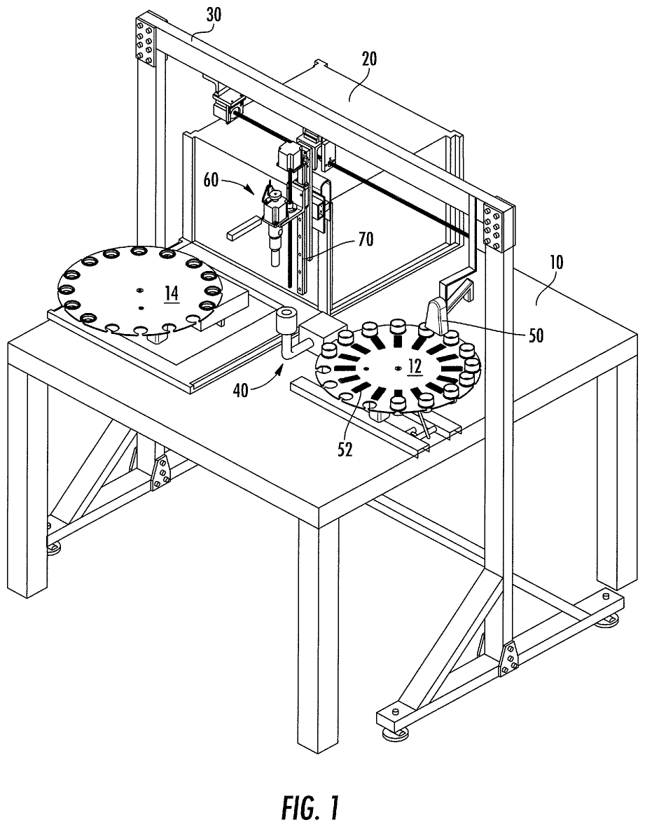

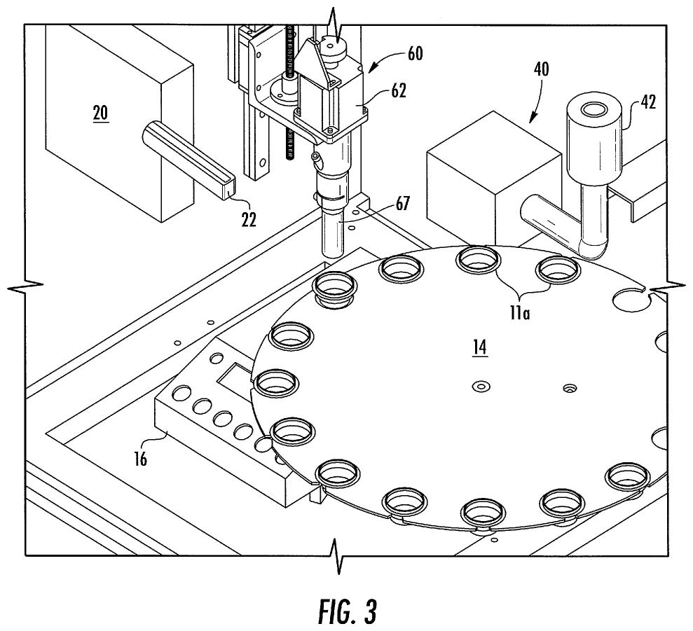

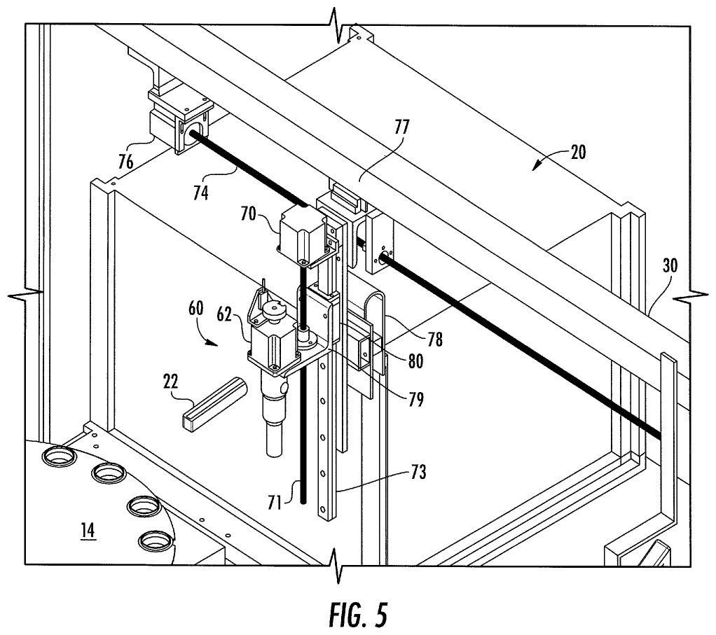

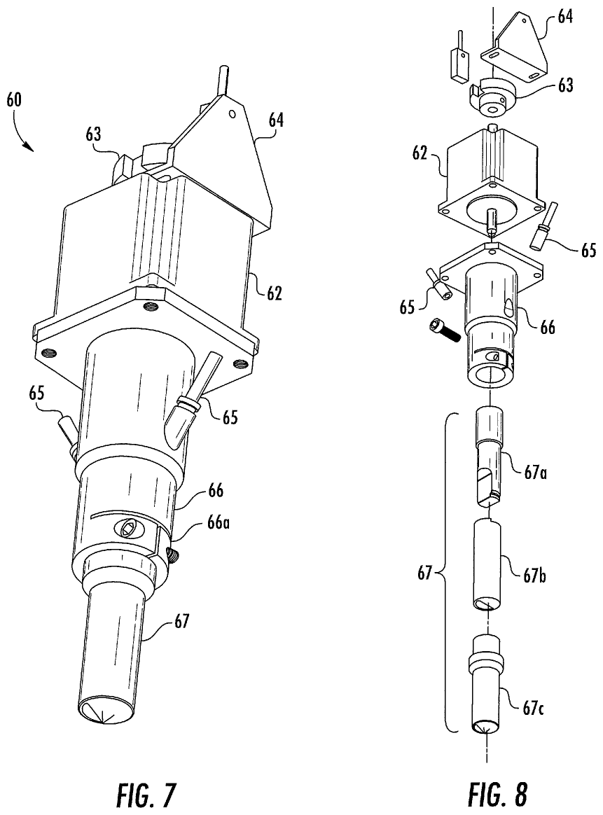

There is shown in FIG. 1 the multiple sample automatic dosing and cleaning system of the present invention that includes a table 10 on one portion of which is a first carousel 12, an external rotating carousel, for receiving samples in sample cups. Multiple different samples cups are arranged in the receiving carousel 12 for automatic sequential picking up, weighing empty multiple receiving cups 11a on a balance scale (16, shown in FIG. 3) and later to be dosed. Receiving carousel 14 is rotated around its axis by a motor (not shown) synchronized with the dosing device 60. On another portion of table 10 is destination carousel 14 with cups 11A for receiving the dosed sample. A dosing device 60 (to be explained in greater detail in FIGS. 7-8) is provided in proximity to the carousels. There is also provided module 20 which is used to provide a second type of dosing or a flux and is positioned in proximity to the destination carousel 14. The carousels are serviced by gantry assembly including support 30 which provides support for moving the dosing device 60 from one carousel to the other, as explained in greater detail in FIG. 5. There is also provided a dosage device cleaning mechanism 40.

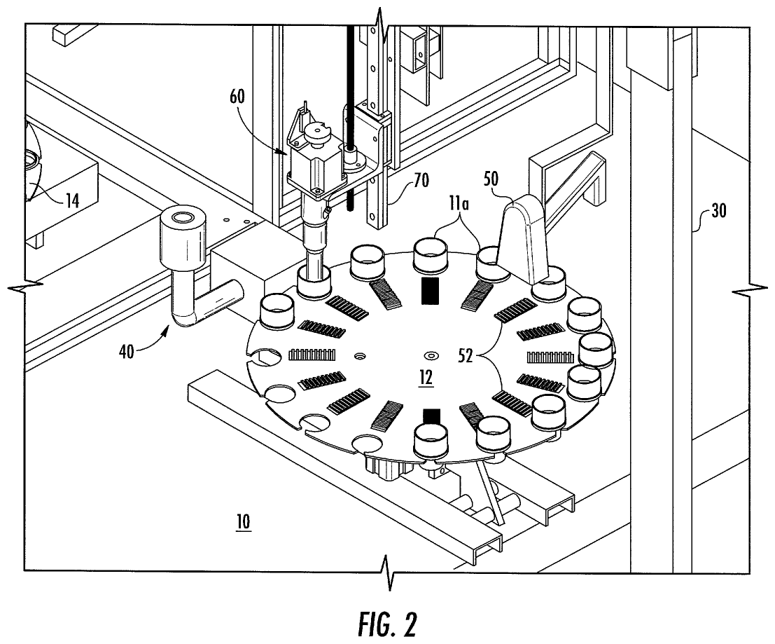

Samples are provided in cups 11 of enough capacity for the dosing device 60 to fill the need volume of sample later used for sample dosing. As shown in FIG. 2, a portion of the dosing system has receiving carousel 12. The dosing device 60, supported by gantry assembly 30, removes a sample from the receiving carousel 12 and transfers the sample to destination carousel 14. The receiving carousel 12 contains bar codes 52 for each sample cup which are read by bar code reader 50.

FIG. 3 shows that portion of the dosing and cleaning system showing dosing head 67 positioned to dose samples in cups 11a which are positioned and deposited on the balance pedestal where the samples are weighed on precision balance scales 16 connected to rotating destination carousel 14 with samples vessels with vertical pneumatic positioning for vessels to be deposited on balance 16. There is also shown dosing device 60 controlled by rotating motor 62. The dosing device 60 doses samples by partially opening and closing an aperture (window, not shown) at high speed. Also shown is vacuum cleaning mechanism 40 that includes vacuum pump 41 and vacuum cleaner 42. Adjacent the destination carousel 14 is the secondary dosing/flux dosing module 20 having dosing tube 22.

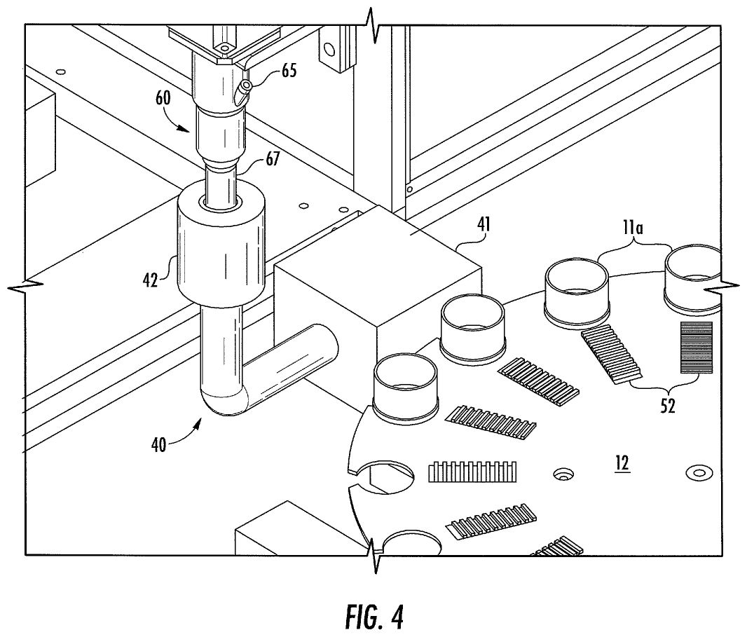

It is essential in order to obtain accurate results that the dosing device 60 be clean before dosing the next sample. The present invention uses a cleaning station, shown in FIG. 4 as cleaning mechanism 40, to clean the dosing device 60 after each sample is dosed and before a new sample is collected. In FIG. 4 there is shown the cleaning mechanism 40 positioned between carousels 12, 14. The cleaning mechanism 40 comprises vacuum pump 41 located in the vacuum box which supports the cleaning when the dosing device 60 is opened and closed repeatedly turning vacuum on and off automatically. The dosing device 60, as shown in FIG. 4, has been lowered into the vacuum cleaner 42, ready for vacuum and compressed air cleaning. A circular brush (not shown) surrounds the dosing device head 67 as it enters the vacuum cleaner 42 and is integrated with the cleaning vacuum system to clean the external part of the dosing device head 67 as it moves inside the cleaning mechanism 40.

Moving the dosing device from carousel to carousel and positions in between is provided by the gantry shown in FIG. 5. The gantry frame 30 supports the various elements. Vertical movement of the dosing device 60 is controlled by the vertical displacement assembly with motor 70 causing the dosing device to move vertically along screw 71. The vertical assembly is supported by angle 79 and moved along support 73 by vertical slider 80 which is connected to linear slider 77. The dosing device 60 is moved linearly along screw 74 which is controlled by linear displacement assembly with motor 76 and supported by linear slider 77. There is provided an external vibrating mechanism 78 to vibrate the dosing device 60 before collecting a sample with dosing device window open, vibrating after collecting the sample with window in dosing device closed to remove part of the excess sample and to support dosing operation later at dosing operation.

The invention also provides a second dosing module or station 20, shown in FIG. 5, to secondarily dose and or flux the sample by balance gravimeter into the same crucible or destination vessel. The second dosing module 20 doses sequentially by vibration or other means to add flux or a secondary dosing to sample cups 11a in the gravimetric moving station when the moving station is positioned in flux dosing position. As shown, the secondary dosing or flux is added through tube 22. This arrangement allows multiple vessels to be dosed at specific amounts before or after the samples are further dosed/fluxed. This operation is repeated until all sample cups 11a have a dosed sample and flux and information of weights of vessel, dosed sample and flux is analyzed.

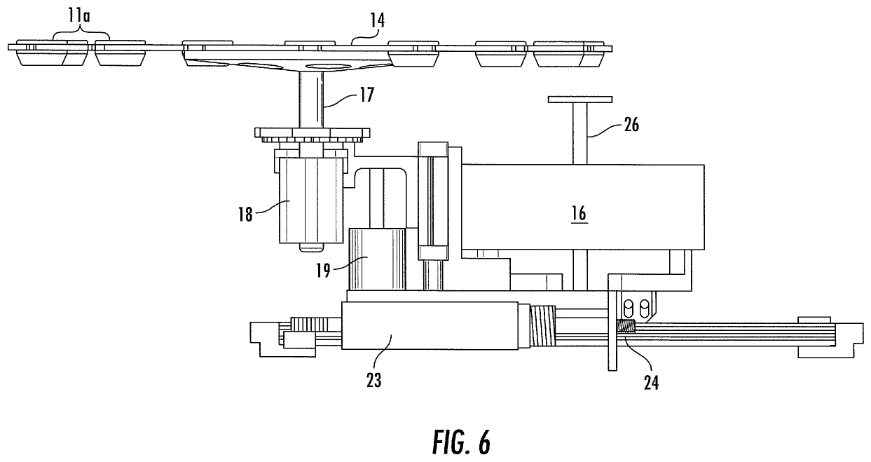

FIG. 6 illustrates the destination carousel assembly, balance weighing and piston assembly for controlling the destination carousel 14. The dosed sample cups 11a are positioned in openings in destination carousel 14 which is rotatable around carousel rotation axis 17 by motor 18. The destination carousel 14 has vertical movement provided by pneumatic cylinder 19 and linear movement provided by pneumatic cylinder 23 operating along slide 24. The vertical and linear movement enables the destination carousel 14 to move to and from the second/flux dosing module 20. The destination empty cups 11a in the destination carousel 14 are automatically deposited on the balance pedestal 26 for weighing by precision balance scales 16. After sample dosing, pneumatic cylinder 23 moves the balance assembly, shown most clearly in FIG. 6, to the flux dosing position to automatically dose flux to sample cups 11a through tube 22 and by module 20 with carrousel 14 in the down position

FIG. 7 is a view of the dosing device 60 and FIG. 8 is an exploded view of the dosing device showing the dosing device 60. The dosing device 60 includes rotation motor 62 being positioned by the motor position indicator 63 and support 64. The rotation motor 62 is supported to vertical assembly by angle support 79 shown in FIG. 5. As dosing device head 67 has the shape of a tube when the device is opened, air, gas or a liquid can easily pass through cleaning entrances 65 and push the remaining sample out of the device. The dosing device housing 66 is connected to rotation motor 62. Extending from the dosing device housing 66 is dosing device head 67 secured by clamp 66a and having a window (not shown) that can automatically open and close. The device head 67 includes rotating motor extension driver 67a, rotating dosing device internal tube 67b and fixed dosing device head 67c.

In operation, a sample is loaded by the dosing device 60 with the window opened to fill to any position then dosing device is lowered to the sample cup 11 and dosing device head 67 is introduced into sample to allow sample to penetrate the dosing device cavity. Vibrating external mechanism 78 may be used to facilitate the dosing device entrance into the samples. The dosing device internal tube 67b is then closed by motor 62 rotation before moving up to capture the sample inside tube 67b. The dosing device 60 is raised to travel height by vertical motor 70 and vibrated to release particles on the device surface to sample cup. The dosing device 60 is moved by linear displacement motor 76 to the appropriate dosing position. The dosing device 60 is then lowered to sample dosing position in the carousel 14 to dose inside vessel.

The window in the dosing device 60 is opened and close repeatedly by rotational motor 62 above the dosing device and at different opening degrees to allow precise dosing of sample to the destination vessel that is now deposited on precision balance 16, readings in balance use by software to regulate degree of window opening and speed of device window opening and closing, vibrating external module 78 can be used to support and complement the device window dosing operation. When dosing is completed the dosing device window is closed. The dosing device 60 raises and moves by vertical motor 70 to cleaning position. When about 50% of the dosing device head 67 enters the cleaning position the vacuum will start, the device window will fully open and compressed air will flush inside of dosing device tube to eliminate any remaining particles left by vacuum. The dosing device head 67 will fully enter cleaning station 40 with vacuum and compressed air operating simultaneously.

The multiple sample automatic dosing system of the present invention includes a carousel with vessels containing samples and flux and a determination of the weights of each sample and flux.

Many modifications and other embodiments of the inventions set forth herein will come to mind to one skilled in the art to which these inventions pertain having the benefit of the teachings presented in the foregoing descriptions. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

I claim:

1. A multiple sample gravimetric dosing and cleaning system for weighing a dosed sample of material comprising:
a gantry assembly for controlling the horizontal and vertical movements of a dosing device;
a first carousel for sequentially receiving multiple samples in cups to be picked up, means for rotating said first carousel and synchronizing said rotation with said dosing device;
a balance scale for weighing samples to be dosed;
said dosing device having a dosing head and being capable of moving said samples from said first carousel, dosing said samples though said dosing head through which the dosing material is moved into said sample cup and moving said samples to a destination carousel;
a cleaning mechanism for cleaning said dosing head following each dosing, said cleaning mechanism being positioned between said first carousel and said destination carousel;
said destination carousel having openings for receiving said dosed sample cups, said destination carousel having means for rotation movement and vertical and horizontal movement.

2. The gravimetric dosing and cleaning system according to claim 1 wherein said gantry assembly comprises:
a support frame for controlling the vertical and horizontal movement of said dosing device;
a vertical displacement assembly that includes motor suitably connected to said support frame for moving said dosing device vertically by vertical slider along a screw; and
a linear displacement assembly the includes a motor supported by a slider along a screw.

3. The gravimetric dosing and cleaning system according to claim 1 wherein said cleaning mechanism for cleaning said dosing device comprises:
a vacuum pump located in a vacuum box which supports said cleaning mechanism;
a cleaner connected to said vacuum pump for receiving said dosing device head;
a circular brush within said vacuum cleaner and surrounding said dosing device head as it enters said vacuum cleaner.

4. The gravimetric dosing and cleaning system according to claim 1 further comprising a secondary dosing or flux device for dosing said samples.

5. The gravimetric dosing and cleaning system according to claim 1 further comprising a vibrating mechanism positioned to vibrate said sample to facilitate said dosing device entrance to said sample and to release particles on the device surface to the sample cup.

6. The gravimetric dosing and cleaning system according to claim 1 wherein said dosing device comprises:
a motor for rotating said dosing head is supported to vertical assembly;
a dosing head housing connected to said motor; and
a dosing head extending from said dosing head housing.

7. The gravimetric dosing and cleaning system according to claim 1 wherein linear and vertical movement of said destination carousal is provided by pneumatic cylinders.

8. A multiple sample gravimetric dosing and cleaning system for analyzing a dosed sample of material comprising:
a gantry assembly for controlling the horizontal and vertical movements of a dosing device; said gantry assembly comprising a support frame for controlling the vertical and horizontal movement of said dosing device; a vertical displacement assembly that includes a motor suitably connected to said support frame for moving said dosing device vertically by vertical slider along screw; and a linear displacement assembly the includes a motor supported by a slider along a screw;
a first carousel for sequentially receiving multiple samples, means for rotating said first carousel and synchronizing said rotation with said dosing device;
a balance scale for weighing samples to be dosed;
said dosing device having a dosing head and being capable of moving said samples from said first carousel, picking up said samples though said dosing head though said dosing head through which the dosing material is moved into said sample cup and moving said samples to a destination carousel;
a secondary dosing device for dosing or fluxing said sample;
a cleaning mechanism for cleaning said dosing head following each dosing, said cleaning mechanism positioned between said first carousel and said destination carousel and comprising a vacuum pump located in a vacuum box which supports said cleaning mechanism, a cleaner connected to said vacuum pump for receiving said dosing device head, and a circular brush within said cleaner and surrounding said dosing device head as it enters said vacuum cleaner;
said destination carousel having openings for receiving said dosed sample cups, said destination carousel having means for rotation movement and vertical and horizontal movement.

9. The system of claim 1 further comprising a vibrating mechanism positioned to vibrate said sample to facilitate said dosing device entrance to said sample and to release particles on the device surface to the sample cup.

10. The gravimetric dosing and cleaning system according to claim 1 wherein said dosing device comprises: a motor for rotating said dosing head is supported to vertical assembly and a dosing head housing connected to said motor; and a dosing head extending from said dosing head housing.
